(19) United States
(12) Patent Application Publication
(10) Pub. No.: US 2014/0148379 A1
(43) Pub. Date: May 29, 2014

(54) Control of Unwanted Bacteria in Fermentation Systems with Bacteriocin

(71) Applicants: Mei Liu, College Station, TX (US); Elizabeth J. Summer, College Station, TX (US)

(72) Inventors: Mei Liu, College Station, TX (US); Elizabeth J. Summer, College Station, TX (US)

(21) Appl. No.: 14/050,185

(22) Filed: Oct. 9, 2013

Related U.S. Application Data
(60) Provisional application No. 61/730,707, filed on Nov. 28, 2012.

(51) Int. Cl. A01N 37/46

(52) U.S. Cl. CPC A01N 37/46
USPC 514/2.4; 435/69.1

(57) ABSTRACT

A method of controlling unwanted bacteria in fermentation processes comprising contacting reactants of the process with an effective amount of bacteriocin. Bacteriocin, both indigenous and produced from independent sources, and optionally bacteriocin plus bacteriophages virulent for unwanted bacteria are used to reduce and control unwanted bacteria.

### CROSS-REFERENCE TO RELATED APPLICATION

This application claims the benefit and priority from U.S. Provisional Patent Application 61/730,707 filed Nov. 28, 2012, the contents and disclosure of which is incorporated herein by reference for all purposes.

### FIELD OF THE INVENTION

This invention relates to a method of reducing unwanted bacteria in fermentation process systems. More specifically, unwanted bacteria are reduced by the use of an effective amount of one or more types of bacteriocin or bacteriocin plus bacteriophages virulent for at least some strains of the unwanted bacteria.

### BACKGROUND

An important type of fermentation process is used to produce biofuels such as those that produce alcohol or lipid and oil based products that are derived from biological sources. Commercial biofuel grade alcohol production (such as bioethanol) can utilize feedstocks of simple sugars and starch sources including seeds (including but not limited to corn seed, wheat seed) as well as high sugar or simple starch content plant materials such as sugar beets, molasses, and sugar cane extracts.

Bioethanol is being widely used in many countries as motor fuels. In the U.S., fuel ethanol production has increased from 1.7 billion gallons in 2000 to almost 12.5 billion gallons in 2009 (see information at www.ethanolrfa.org/pages/statistics). The number of ethanol fermentation facilities is also rapidly increasing, from 110 U.S. plants operating in 2007 to 187 in 2010. The majority of commercial bioethanol fermentation plants in the U.S. are designed to utilize a grain feedstock, primarily corn, which is fermented by microorganisms, especially yeast, into ethanol. In standard operation, the complex carbohydrate chemistry of the feedstock is converted into simpler sugars by a combination of enzymatic (e.g. amylase or other starch-hydrolyzing enzyme) and/or physical (e.g. temperature and shearing) and/or chemical (e.g. by treatment with dilute sulfuric acid or other chemicals) treatment, forming a liquefied mash. Simple sugars in the liquefied mash are then used as substrates for ethanol fermentation by yeast. Cellulosic and lignocellulosic feedstocks are an attractive alternative to grain feedstocks, although they present additional challenges in terms of preparing the fermentable substrate.

Chronic and acute bacterial contamination of the fuel ethanol fermentation process is common. Bacteria may initially enter the process with the feedstock, the yeast or be present at the facility, for example on equipment, in liquids or in biofilms that serve as reservoirs for the bacteria. Bacteria may also persist in the fermentors, along piping turns, and in heat exchangers and valves. While bacterial levels vary during the different steps preparing the grain substrate for fermentation, by the time the processed mash is ready for yeast inoculation, the total bacterial levels in a normal, “healthy” fermentation facility are around 10⁶ colony forming units (CFU) per ml in a wet mill and as high as 10⁸ CFU/ml in a dry-grind facility (Skinner, K. A. and T. D. Leathers (2004). “Bacterial contaminants of fuel ethanol production.” J Ind Microbiol Biotechnol 31(9): 401-8). However, bacterial levels higher than this frequently develop, negatively impacting ethanol yields. The most widely cited agents responsible for fuel ethanol fermentation slowdown are lactic acid bacteria (LAB), primarily members of the Gram-positive genera Lactobacillus, Pediococcus, Leuconostoc and Weissella (Bischoff, K. M., S. Liu, et al. (2009). “Modeling bacterial contamination of fuel ethanol fermentation.” Biotechnol Bioeng 103(1):117-22). Other acid producing bacteria may also be a problem.

Unwanted bacteria inhibit the yeast fermentation process through the competitive consumption of sugars, which bacteria convert into organic acids instead of ethanol. These organic acids, primarily lactic and acetic, are inhibitory to the vitality of the yeast. Infections may be chronic, resulting in an overall constant loss of production efficiency, or acute, resulting in stagnated—or “stuck”—fermentation that requires the system be shut down for decontamination. Even a 1% decrease in ethanol yield is significant to ethanol producers. At an average 50 million gallons per year (mgy) plant, a 1% loss equates to a decrease of 500,000 gallons of ethanol per year.

Bacterial control methods have an immediate positive impact and even a simple one-log reduction in the amount of LAB can increase ethanol yield by approximately 3.7% (Bischoff, Liu et al. 2009). Bacterial contamination in fuel ethanol plants is typically controlled by a combination of plant management approach and the addition of chemical antimicrobials and antibiotics. The types and amounts of chemicals that can be used to control LAB are limited because the compounds must reduce bacteria without affecting the yeast culture and must also not carry over as harmful residue in the solid co-products of fuel ethanol fermentation, which is frequently sold as distillers dried grains with solubles (DDGS) for animal feeds. The plant management approach involves the routine cleaning of equipment and reactors, as well as controlling physical and chemical parameters such as temperature, pH, and acid levels to favor yeast over bacterial growth. Chemical antimicrobials that can be added to reduce bacterial levels include typical quaternary compounds and gluteraldehyde, as well as more specialized formulations such as a stabilized ClO₂ product sold by DuPont under the trade name FermaSure™.

Not surprisingly, antibiotics, in particular virginiamycin and penicillin, are particularly effective in curbing bacterial populations without disturbing the yeast. This has led to the widespread use of antibiotics in the fuel ethanol fermentation industry. However, antibiotic residue has been detected in the solid distillers' grain residue that is sold as livestock feed. Additionally, there is evidence that antibiotic use leads to selection for antibiotic resistance (Bischoff, Skinner-Nemec et al. 2007). Even though effective, it is generally agreed that there needs to be an end to indiscriminate, non-therapeutic use of antibiotics. Thus, the ethanol industry in particular, and the biofuel industry in general, needs to move quickly to replace antibiotics.

Bacteriocins are proteins or complexed proteins biologically active with antimicrobial action against other bacteria, principally closely related species, whereas producer cells are immune to their own bacteriocins (Cotter, P. D., Hill, C., and Ross, R. P. (2005b) Bacteriocins: developing innate immunity for food. Nat. Rev. Microbiol., 3, 777-788). One general target for bacteriocin is the bacterial cell wall, the essential structure feature of bacteria. Bacteriocins generally inhibit the biosynthesis (causing pore formation) of the cell wall or membrane of the target organisms, subsequently resulting in bacterial death (Nishie M., Nagao J., Sonomoto K., (2012) Antibacterial peptides “bacteriocins”: an overview of their diverse characteristics and applications. Biocontrol Sci. 17(1):1-16). A significant portion of the currently well characterized bacteriocins are produced by lactic acid bacteria (LAB). Bacteriocins produced by LAB are usually small, ribosomally synthesized, antimicrobial peptides, and have attractive application potentials because LAB producers have GRAS (generally recognized as safe) status as designated by the U.S. Food and Drug Administration (FDA). Bacteriocins may be produced and added to bacteria containing media for bacterial control or bacteriocin-producing bacteria, may be added under conditions promoting bacteriocin production with the efficacious bacteriocins being produced in-situ.

Bacteriophage, or phage, are viral predators of bacteria.

Bacteriophages or phages are natural, ubiquitous bacteriolytic agents with extremely high host specificity. Phage formulations and antibiotics both have advantages over the majority of chemical biocides in that they specifically kill target unwanted host bacteria without interacting with non-bacterial microorganisms (such as yeast or algae) responsible for alcohol or oil production. In contrast, general chemical biocides are much less selective and doses effective against bacteria may adversely modulate growth of the biofuel producing organisms. Bacteriophages are thus safer to use than other antibiotics. Phages have been approved by the FDA as a food additive, specifically for the control of the food-borne pathogen Listeria on commercial luncheon meats. Commercial phage products sold in the U.S. include AgriPhage, sold by Omnilytics, designed to control Xanthomonas infestations in peppers and tomatoes and Finalyse, sold by Elanco Foods, designed to control E. coli O157:H7 levels on slaughterhouse cattle.

The present invention utilizes bacteriocin and optionally bacteriocin plus bacteriophage for control of unwanted acid-producing bacterial in fermentation processes, especially biofuel—bioethanol fermentation processes. The combination of bacteriocin plus bacteriophage extends the range of control beyond that which can be achieved by use of bacteriocin or bacteriophage alone.

### SUMMARY

In broad scope the present invention is a method of controlling unwanted bacteria in fermentation processes comprising contacting reactants of the process with an effective amount of bacteriocin. Bacteriocin, both indigenous and produced from independent sources, and optionally bacteriocin plus bacteriophages virulent for unwanted bacteria are used to reduce and control unwanted bacteria.

### DESCRIPTION OF THE DRAWINGS

FIG. 1 is a diagrammatic representation of an ethanol fermentation process flow scheme.

FIG. 2 is a bar graph showing results of the efficacy of bacteriocin on a sample of corn fermentation mash.

### DETAILED DESCRIPTION

The present invention is a method of control of unwanted bacteria in non-bacterial, or eukaryotic metabolic reaction processes for fermentation products. Bacteriocin and optionally bacteriocin plus bacteriophages are used to reduce and control unwanted bacteria. In one embodiment bacteriocin or bacteriocin plus phages (virulent for unwanted LAB bacteria) are used to control unwanted bacterial species in sugar/starch and/or lignocellusosic feedstock ethanol processes utilizing a eukaryotic (non-bacterial) fermentative organism(s) such as yeast. In a preferred embodiment, the unwanted bacterial species targeted are from acetic and lactic acid producing genera, especially those referred to as lactic acid bacteria where the feedstock is grain or other starch or sugar source. An example is unwanted lactic acid bacteria (LAB) in a yeast-based fermentation stage of ethanol production.

Bacteriocin produced by LAB bacteria kills related bacteria but, generally, not the host or producing bacteria. Thus, a combination of bacteriocin virulent for certain LAB bacteria found in fermentation processes with bacteriophage virulent for the same or other (preferably bacteria not killed by the bacteriocin) greatly extends the scope of control of unwanted bacteria that adversely affect fermentation-based ethanol production.

Bacteriocins are usually antimicrobial peptides produced by bacteria, particularly Gram-positive bacteria, to inhibit the growth of related species or other genera at high potency. Lactic acid bacteria (LAB) are a group of popular bacteriocin-producing bacteria, with a number of bacteriocins produced by LAB strains discovered and well characterized. Bacteriocins produced from LAB can be classified into three groups: small and heat stable bacteriocins containing lanthionine (class I bacteriocin, or lantibiotics), small and heat-stable non-lanthionine-containing bacteriocins (Class II), and large and heat-labile lytic proteis (Class III). LAB are of GRAS (generally recognized as safe) status as designated by the U.S. Food and Drug Administration (FDA), and some of the broad spectrum bacteriocins produced by LAB are used commercially in food and pharmaceutical industries. Examples include nisin produced by Lactococcus lactis and pediocin produced by Pediococcus acidilactici, which have been used as commercial food preservative world-wide (De Vuyst L., Leroy F., (2007) Bacteriocins from lactic acid bacteria: production, purification, and food applications. J Mol Microbiol Biotechnol. 13(4):194-9.) (Nishie M., Nagao J., Sonomoto K., (2012) Antibacterial peptides “bacteriocins”: an overview of their diverse characteristics and applications. Biocontrol Sci. 17(1):1-16.).

Plant material-based fermentation processes often suffer from LAB contamination, causing production of acid rather than alcohol and therefore the inhibition of yeast activity, resulting in significant product yield loss. Bacteriocins including those produced by the indigenous LAB population will act towards species and/or strains of the indigenous LAB population and thus are effective for control of contaminating LAB.

### Illustrative Ethanol Production Process Description

There are basically two methods for conversion of corn (or other starch natural products) to ethanol by fermentation: the dry mill process and the wet mill process.

In the dry-grind method, the entire corn kernel is ground into a coarse flour or meal, then slurried with water to form a “mash.” The mash is then cooked, treated with enzymes (e.g. amylase or other starch-hydrolyzing enzyme), fermented and distilled. By-products of the dry-grind process include distillers grains, a high-quality livestock feed, and carbon dioxide, a food and industrial product. In the wet mill process a number of corn products are separated before conversion of starch to sugar for fermentation and only the starch extract is fermented to ethanol. Most producers of ethanol from corn plants, perhaps more than 80% in the US, use the dry process.

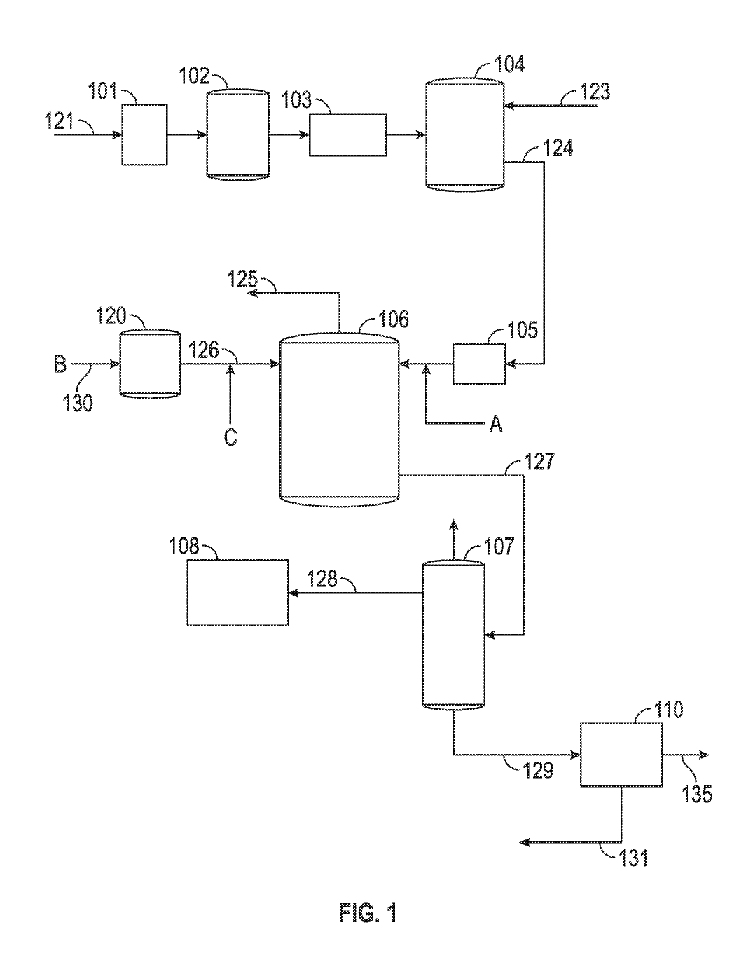

FIG. 1 illustrates a flow scheme for a process for ethanol production using yeast for the fermentation phase. Corn enters the process at 121 to a grinding mill (usually a hammer mill) 101 and the milled grains pass to vessel 102 where water is added to slurry the corn meal. From 102 it passes to cooker 103. “Liquefaction is accomplished using jet-cookers that inject steam into the corn flour slurry to cook it at temperatures above 100° C. (212° F.). The heat and mechanical shear of the cooking process break apart the starch granules present in the kernel endosperm, and the enzymes break down the starch polymer into small fragments. The cooked corn mash is then allowed to cool to 80-90° C. (175-195° F.), additional enzyme (a-amylase) is added, and the slurry is allowed to continue liquefying for at least 30 minutes.” (Nathan S. Mosier and Klein Ileleji; How Fuel Ethanol Is Made from Corn; Department of Agricultural and Biological Engineering Purdue University; ID 328).

The liquified mash then passes to vessel 104 for “saccharification” where enzymes are added to split the starch into glucose molecules. After liquefaction, the slurry, now called “corn mash,” is cooled to approximately 30° C. (86° F.), and a second enzyme (glucoamylase) is added. Glucoamylase completes the breakdown of the starch into simple sugar (glucose). This step, called “saccharification,” often occurs while the mash is filling the fermentor in preparation for the next step (fermentation) and continues throughout the next step”. See Mosier and Ileleji above. The mixture is then cooled, 105, and passed to the fermentor(s) 106 and yeast is added (120 and 126). CO₂ is removed 125 from the fermentor and ethanol solution, “beer” is removed to distillation 107. The concentrated ethanol passes to 108 for further processing and the solids by 128 to 110 for further processing. Antibiotics may be added to the process in the fermentor or upstream in the liquefaction step.

“In the fermentation step, yeast grown in seed tanks (yeast propagators), 120, are added to the corn mash (conduit 126) to begin the process of converting the simple sugars to ethanol. The other components of the corn kernel (protein, oil, etc.) remain largely unchanged during the fermentation process. In most dry-grind ethanol plants, the fermentation process occurs in batches. A fermentation tank is filled, and the batch ferments completely before the tank is drained and refilled with a new batch”. See Mosier and Ileleji above. A batch will generally be processed in the fermentor for about 48 hours but the time will vary with conditions and specific fermentation process. In many sugar processes such as those processing sugars from sugar cane (as in Brazil) the fermentation process is continuous—involving a series of cascading fermentation vessels or tanks into which sugar solution and yeast are continually added and products continuously removed.

Yeast is added to the fermentation vessel(s) via 126 from yeast processing unit 120. A substantial amount of yeast (in some processes 10-14 cell mass/volume) is used and therefore in many processes (particularly the continuous processes in Brazil) yeast is recovered, processed and recycled as from 131 to 130. The bacteria population in the yeast and yeast processing step will be somewhat different from that in the fermentation feed from 105 and therefore it will be desirable to provide bacteriocin and bacteriocin and phage tailored to the bacteria in the yeast unit and the feed units.

In the dry mill process only the starch components processing (saccharification, fermentation and downstream processing) and yeast propagation is relevant to the present invention and is basically the same process steps as in the wet process. In processes using sugar, such as from sugar cane, the saccharification stage will not be needed, the feed preparation steps will be different from the dry mill corn process but the fermentation and yeast processing will be similar.

Bacteriocin and optionally bacteriocin plus bacteriophage virulent for the targeted unwanted bacteria will be added in effective amounts to the fermentation step feedstock, the corn mash, the saccharification process or product, the yeast or directly into the fermentation vessel(s) or as described in more detail below. It is preferred to inject bacteriocin and/or phage into fermentation step (A in FIG. 1) or into the input stream. There is sufficient time for bacteriocin and for phage to kill unwanted bacteria before sufficient acid is produced to interfere with alcohol production. While bacteriocin may survive cooking (103,) the population of bacteria changes with conditions in each stage so bacteriocin will not be as effective in getting the targeted bacteria if not added at the fermentation stage.

In general, lactic acid and other acids are produced from the beginning of the fermentation step and are best controlled from the outset. It is important that the unwanted bacteria be controlled prior to sufficient fermentation in the fermentation reactor. Control of the unwanted bacteria during the first 20% of time and preferably during the first 10% of time in the fermentation cycle is preferred. This early control is critical for effectiveness. Once lactic acids and/or other acids are produced in the fermentation reactor, they cannot be reversed. Control of unwanted bacteria in the feed materials (and/or yeast preparations) to the fermentation is thus preferred—if no unwanted bacteria enter the fermentation cycle, no unwanted acids will be produced.

Particularly in the sugar cane processes where yeast is recovered, processed and reused, the yeast at 120 is customarily treated with sulfuric acid to kill unwanted bacteria. Strong acid may decrease the activities of bacteriocin and generally will kill phage so the bacteriocin treatment of this invention may be substituted or complemented for acid treatment, the acid treatment moderated or the acids neutralized before contacting with bacteriocin and phage. Bacteriocin and/or bacteriocin and phage may be injected at points B and/or C in FIG. 1.

Bacteriocin may be isolated, purified and used in solution (usually aqueous solution) for treatment of the ethanol fermentation feed, equipment or added to the fermentation reactor. In one aspect bacteriocin-producing bacteria may be used rather than bacteriocin if the conditions and time is sufficient for the bacteria to produce sufficient bacteriocin before the significant onset of lactic acid production in the system.

Bacteriocins Used in Combination with Phage

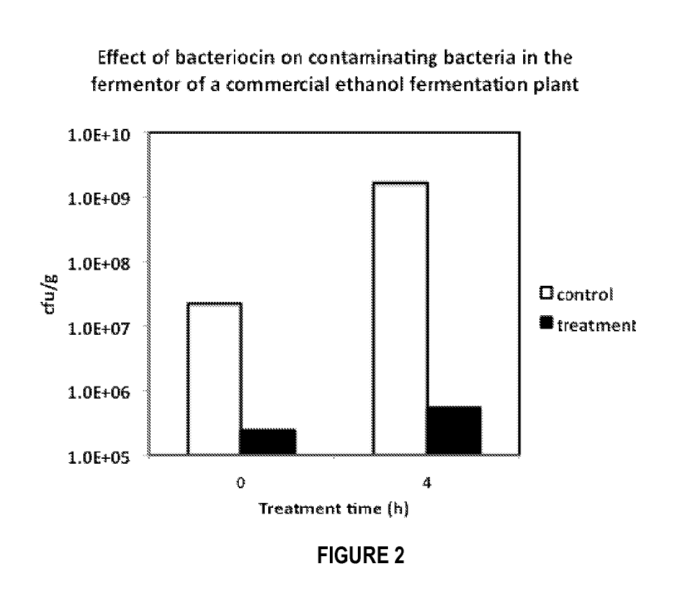

Bacteriocins can be used in combination with phage for controlling contaminating bacteria during fermentation. The combination of bacteriocins and phage ensures a broader inhibition spectrum and more efficient control of the bacteria contamination. For example, though the bacteriocin produced by Lactobacillus sp. strain GP15 exhibits broad host range in inhibiting LAB (FIG. 2), a very small number of strains of LAB are not sensitive to this bacteriocin. Phage targeting these non-sensitive strains can be isolated, and be combined with the bacteriocin for a complete control of contaminating bacteria. Bacteriocin and phage can be added to ethanol fermentation at the same time, or added sequentially depending on the growth kinetics of their respective target hosts. It is also possible to use the same bacteriocin-producing strain as the phage propagation host, to obtain the simultaneous production of bacteriocin and phage in one culture.

Bacteriocins Used in Combination with Phage-Derived Antimicrobial Proteins

Bacteriocins can also be used in combination with lytic proteins of phage origin for bacteria control during ethanol fermentation. Endolysins produced by phage are bacterial cell wall degrading enzymes that allow phage to be released from the host cells during the phage lytic cycle (Schmelcher M, Donovan D M, Loessner M J., Bacteriophage endolysin as novel antimicrobials. Future Microbiol. 2012 October; 7(10):1147-71). Phage endolysins have been shown to be synergistic with a range of other antimicrobials, including bacteriocins. For example, it has been demonstrated that when the endolysin produced by Staphylococcal phage was combined with nisin, a strong synergistic effect was observed. Clearance of bacteria pathogen in contaminated milk was only achieved by the combined activity of both antimicrobials (García P, Martínez B, Rodríguez L, Rodríguez A., Synergy between the phage endolysin LysH5 and nisin to kill Staphylococcus aureus in pasteurized milk. Int J Food Microbiol. 2010 Jul. 15; 141 (3): 151-5).

Many species of Gram-negative and Gram-positive bacteria have been reported to produce a special group of bacteriocins, which are high-molecular-weight phage tail-like particles. These particles resemble defective phages, probably derived from temperate phages via mutations. These phage tail-like bacteriocins are comparable to phage in having narrow host specificity. These phage tail-like bacteriocins can offer selective elimination of certain target bacteria if needed.

Bacteriocins Used with Other Antimicrobial Agents

Bacteriocins can also be used in combination with non-phage based chemical antimicrobial agents and/or physical treatments to achieve optimal control of the contaminating bacteria during biofuel fermentation process.

Bacteriocin and bacteriocin producing bacteria may be stored and preserved for transport and later use by spray-drying the bacteria as has been demonstrated for dairy LAB by J. Silva, A. S. Carvalho, P. Teixeira and P. A. Gibbs (J. Silva, A. S. Carvalho, P. Teixeira and P. A. Gibbs; Bacteriocin production by spray-dried lactic acid bacteria; Letters in Applied Microbiology 2002, 34, 77-81).

Although the present invention is focused on treating LAB in grain feedstock fermentation in particular, and non-bacterially-driven fermentation processes in general, it will be clear to those skilled in the arts of microbiology, biofuel production, and related fields, that the invention may be applied to any similar production process, so long as: 1) the process is driven by one or more non-bacterial (eukaryotic) or biofuel generative reactive agents, and 2) it is desirable to control one or more unwanted bacterial strains. Examples of alternative embodiments include, but are not limited to, controlling unwanted bacteria in: fermentation of feedstock by fungi; biofuel lipid and oil production using algae (eukaryotic algae), such as is used in the production of some biodiesels; and production of enzymes from fungus (e.g. Trichoderma reesei) for immediate or later use in biofuel production.

As used herein the term bacteriocin refers to proteins or complexed proteins produced by certain bacteria that are biologically active with antimicrobial action against other bacteria, principally closely related species. Bacteriocins produced by LAB are generally small, ribosomally synthesized, antimicrobial peptides or proteins that possess activity towards closely related Gram-positive bacteria, whereas producer cells are immune to their own bacteriocin(s).

As used herein an “effective” amount of bacteriocin or bacteriophage is the amount that will kill a detectable amount of targeted unwanted bacteria. Exact dosage depends on the nature of the fermentation material for which it is intended. For bacteriocin this generally is at least in or above nanomolar concentration range and for bacteriophage is at least a concentration of 10⁵ phage particles per ml and preferably at least 10⁶ phage particles per ml.

As used herein, it is understood that the terms “phage(s)” and “bacteriophage(s)” are synonymous and includes all of the viral predators of bacteria.

The term “unwanted bacteria,” as used herein, refers to the strain(s) of bacteria specifically targeted for control by the invention described herein. Typically, but not necessarily, the unwanted bacteria is targeted for control because of interference with the reaction(s), such as in the case of unwanted acid producing bacteria (such as LAB and acetic acid producing bacteria) in yeast-based ethanol fermentation. The unwanted bacteria need not necessarily be known, isolated, or identified; the sole defining characteristic is that it is the organism(s) desired to be controlled. This invention provides for reduction of invasive bacteria and other unwanted and problematic bacteria.

The term “cocktail,” as used herein, includes multiple bacteriocin and/or bacteriophage for control of a single group of similar targeted unwanted bacteria (such as a single species or sub-species of bacteria). This is different from a “panel,” which is a collection of bacteriocin and/or phages chosen to target a particular range of host strains (such as a genus, or multi-species of bacteria). For the purposes of this invention, the bacteriocin and/or phage treatment will be comprised of one or more “panels,” each comprised of one or more “cocktails,” that is, there will be one or more virulent bacteriocin and/or phage targeting each unwanted bacterial strain and one or more cocktails targeting one or more unwanted bacterial species or genera. Therefore, as used herein, it is understood that “panel(s)” refers in the broadest sense to a combination of one or more bacteriocin and/or phage(s) intended for control of one or more bacterial strains. It encompasses everything from one cocktail comprised of one bacteriocin or phage strain, to many cocktails, each comprised of many bacteriocin and/or phage strains. A “multi-panel” refers to one or more panels, or the total suite of bacteriocin and/or phage strains used in a particular application.

### Bacteriocin Purification and Characterization

To characterize bacteriocins for illustration of the method of this invention, environmental LAB from ethanol fermentation process plants were isolated and purified. The capability of the isolated LAB strains to produce antimicrobial compounds is identified, and the inhibitory activity spectrum of the identified antimicrobial compound is determined against a range of different strains. The characteristics of the identified antimicrobial compound (the putative bacteriocin) are determined. This includes elucidating their proteinaceus nature, chemical stability, activity ranges, production kinetics, molecular weights, protein sequences and structures. Either crude, partially purified or completely purified bacteriocins were used for the characterization study. The crude bacteriocin refers to the bacteriocin in the form of raw bacterial supernatant (cell-free portion of the bacterial culture). The partially purified bacteriocin refers to chemically precipitated and extracted fractions. The purified bacteriocin refers to the bacteriocin purified to chemical homogeneity.

### Bacteriocin Precipitation, Extraction and Purification

Bacteriocin molecules produced by a host bacteria can be extracted, concentrated, and then purified, via a variety of different strategies. For example, bacteriocin molecules can be precipitated out from the bacterial culture supernatant by using ammonium sulfate salting out method, where a desired saturation percentage of salt is reached by adding ammonium sulfate slowly to the cell-free bacteriocin-containing culture supernatant. After incubating, the salt suspension is agitated overnight at 4° C., the salted-out proteins are precipitated by centrifugation and dissolved in a small volume of appropriate buffer, such as phosphate buffer (10 mM, pH 7.0). The precipitated mixture is desalted by dialysis with membrane of appropriate molecular weight cut-off. Bacteriocin molecules in the cell-free bacterial supernatant can also be extracted using organic solvents, such as cold acetone. The acid mixture can then be centrifuged to concentrate the extracted bacteriocin molecules, which exist in the peptidic fraction in the pellet. The concentrated bacteriocin molecules can be purified, typically via chromatography-based methods. Based on the knowledge of the target bacteriocin characteristics such as its estimated size, molecule net charge at a definite pH, adsorption affinity, molecule polarity and hydrophobicity, etc., different separation strategies can be used. The strategies include size exclusion, ion exchange, gel filtration, hydrophobic interaction, reverse phage liquid chromatography, etc. For example, the bacteriocin extract can be passed through a size exclusion chromatography separation column and the mixture can be separated into fractions of different molecule sizes. Ion exchange chromatography, using either cation or anion exchange columns, can also be used to separate the bacteriocin extracts based on their electric charge at a definite pH. In addition to the conventional chromatography columns, centrifuge-based protein separation cartridges are commercially available and can also be used for bacteriocin purification. Multiple chromatography-based strategies may need to be combined for optimal separation.

### Chemical Characterization of Bacteriocin

Either using crude, partially purified or purified form, the chemical characteristics of the bacteriocins are determined. The determined characteristics include their sensitivities to different proteolytic and lipolytic enzymes, stability at different temperatures and pH values, molecular weights, protein sequences and structures. For example, it was determined that the broad host range bacteriocin produced b Lactobacillus sp. strain GP15 has 50% reduction in activity at temperatures of 60-100° C. with a 87.5% reduction seen at a temperature of 120° C. However, there was not a complete loss of activity seen even after 2 hours at 120° C. The same bacteriocin has optimal activity in the pH range of 4-10. There is a complete loss of activity at pH 12, and there is a 50% reduction in activity at pH values of 1, 2, 3, and 11. The activity loss at the extreme pH values does not appear to be reversible. After the bacterocin is purified to homogeneity, its molecular weight, amino acid sequence and structure can be determined with precision using standard chemical analysis methods such as mass spectrometry and nuclear magnetic resonance (NMR) spectroscopy.

### Production Kinetics and Activity Range

Bacteriocin production depends, inter alia, on the host growth, and the production kinetics can be determined by quantifying the bacteriocin levels at different stages of host growth. For example, the bacteriocin production in Lacobacillus sp. strain GP15 appear to start when the host cells reach late-logarithmic and early stationary growth phase after which a rapid production rate is observed and the maximum level of bacteriocin is reached when host cells enter mid-stationary growth phase. The active concentration range and the minimum inhibition concentration of the bacteriocin are determined using different indicator strains. The activity levels of the bacteriocin present in the raw bacterial culture supernatants and/or in partially purified mixtures are determined. This information serves important guideline for real application.

### Bacteriocin Production for Therapeutical Purposes

Identified bacteriocins can be produced in several ways: (1) using native bacterial host strains directly (native expression systems in prokaryotic cells); (2) using recombinant protein expression systems in non-bacteriocin-producing bacterial strains (heterologous expression systems in prokaryotic cells), (3) using yeast-based expression systems (heterologous expression systems in eukaryotic cells). Bacteriocins are produced at large scales for therapeutical purposes, often replying on commercially available fermentors. After their production, bacteriocins are separated from the microbial cells and either crude or partially purified bacteriocins are used for application in controlling bacterial contamination during biofuel fermentation. Alternatively, bacteriocins may be produced in situ by the above-mentioned microbial systems during ethanol fermentation process.

### Bacteriocin Production in Native Host Strains (Native Expression Systems in Prokaryotic Cells)

The culturing conditions of the bacteriocin-producing strain are first optimized in a small volume batch culture to achieve the maximum yield of bacteriocin production. The optimized parameters include the media composition, anaerobic conditions, culture temperature and pH, etc. Bacteriocin production can also be achieved in fed-batch cultures where the determined limiting nutrient substrates are fed to the culture to sustain the high level bacteriocin production for a longer time. In addition to maximizing bacteriocin yields, the optimized parameters will also consider the culture volume scale-up and down stream concentration and purification of bacteriocin if applicable. Production of bacteriocins at large scales will be achieved in large volume culture vessels or commercial fermentors.

The genetic determinants of a bacteriocin usually include genes encoding bacteriocin, genes encoding transporters required for the processing and transport of the bacteriocin, genes encoding proteins required for bacteriocin regulation and modification, and genes encoding the protein which confers host immunity against the toxicity of the produced bacteriocin, etc. Bacteriocin-related genetic elements can be identified by screening the constructed genomic library of the host for corresponding functions. Alternatively, the chromosome and plasmids of the native host can be sequenced, and genetic determinants of bacteriocins can be identified based on the protein homologies shared between the genome-deduced amino acid sequences with the experimentally determined bacteriocin amino acid sequence, as well as the known protein sequence database. Amino acid sequence homologies may exist not only within the mature peptides of bacteriocins, but also in the associated proteins involved in bacteriocin secretion and processing. With the knowledge of host genomics and bacteriocin genetic organization, it is possible to obtain bacteriocin over-producing mutants of the host strain via natural mutation events or specific genetic manipulation. The optimal growth conditions of these bacteriocin over-producing mutants will be determined to achieve bacteriocin production at a much higher level.

### Bacteriocin Production Using Recombinant Protein Expression Systems in Non-Bacteriocin-Producing Stains (Heterologous Expression Systems in Prokaryotic Cells)

To achieve high production levels, heterologous production of bacteriocins in alternative background (other than the native producing hosts) can be carried out. These heterologous expression systems utilize bacteria hosts with well-understood genetics and readily available genetic tools, and thus facilitate effective and strict control of recombinant gene expression at the transcriptional and/or translational level. These protein expression systems are also developed to be compatible with downstream protein purification and large-volume scaling up. One common host for cloning and expressing heterologous genes is the Gram-negative bacteria Escherichia coli. The biological characteristics of E. coli are well understood, and many protein-expression plasmid systems are commercially available. Numerous proteins are produced in E. coli-based systems and are used for industrial applications. Other than E. coli, some Gram-positive bacteria, including many LAB hosts, can also be used as alternative hosts for bacteriocin expression. For example, bacteriocins natively originated from Enterococcus, Lactobacillus, and Pediococcus, have been successfully produced using Lactococcus lactis as the heterologous host.

The heterologous bacteriocin production systems are usually comprised of host cells with high copy number plasmid expression vectors, which carry genetic elements encoding bacteriocin production, regulation, transportation, secretion, etc. These genetic determinants of bacteriocins can be identified by screening the constructed genomic library of the host. Alternatively, the chromosome and plasmids of the native host can be sequenced, and genetic determinants of bacteriocins can be identified based on the protein homologies shared between the deduced amino acid sequences based on chromosome sequence with the experimentally determined bacteriocin amino acid sequence, and/or known protein sequence database. Amino acid sequence homologies may exist not only within the mature peptides of bacteriocins, but also in the associated proteins involved in bacteriocin secretion and processing. It is common that the bacteriocin structural genes, which directly encode bacteriocin, are located in the same cluster as other genes involved in bacteriocin regulation, modification, transportation, and host immunity. The identified bacteriocin genetic determinants can be cloned into plasmid expression vectors, and the vectors can then be transformed into the expression host cells. In addition to relying on the native biosynthetic and transportation genes for bacteriocin production, genetic engineering of the bacteriocin and/or associated genes can be carried out to result in hybrid proteins, for more efficient production and secretion.

It is also feasible to use phage instead of plasmid expression vectors to express bacteriocins. The bacteriocin genetic determinants can be engineered into phage and the expression of bacteriocin will be driven by phage-oriented promoters. Phage of high burst size (number of progeny phage released after each lysis cycle) will be chosen for this purpose. The engineered phage will multiply during infection of host, and the phage-host interaction will be optimized to allow maximum rounds of infection and thus high level of bacteriocin expression. Instead of using crude or partially purified bacteriocin independently produced separate from ethanol fermentation processes, it is possible to use bacteriocin-producing bacteria as biocontrol agents and incorporate them in the ethanol fermentation process for in situ bacteriocin production. It is necessary to render certain traits of the bacteriocin-producing strains (such as acid production) so that their metabolic activities during ethanol fermentation are benign to the proper performance of ethanol fermenting yeasts.

### Bacteriocin Production in Yeast (Heterologous Expression Systems in Eukaryotic Cells)

Besides expressing bacteriocin in bacterial cells, another feasible strategy is to produce bacteriocin heterologously in eukaryotic cells, particularly yeast cells. Genetic tools developed for yeasts can be used to express bacteriocin genes, and the development of bacteriocinogenic yeast strains were successful in Saccharomyces cerevisiae. For example, bacteriocin produced by Enterococcus faecium (enterocin) were cloned on the expression and secretion vector under the control of yeast promoters and heterologous production the bacteriocin was achieved in S. cerevisiae.

Commercial ethanol fermentation industries reply on certain strains of S. cerevisiae to convert plant-based raw substrates into ethanol. It is possible to genetically engineer these S. cerevisiae strains used in ethanol fermentation industry to produce bacteriocin. Despite the public opposition towards the genetically modified organisms (GMOs), the use of bacteriocinogenic S. cerevisiae allows advantageous yeast self-protection against contaminating bacteria during ethanol fermentation.

After their production, bacteriocins are separated from the producing hosts and either crude or partially purified bacteriocins are used for real application. Instead of using the bacteriocins independently produced separate from fuel fermentation processes, it is possible to use bacteriocin-producing microorganisms as biocontrol agents and incorporate them in the fuel fermentation process for in situ bacteriocin production. It is necessary to render certain traits of the bacteriocin-producing hosts (such as acid production from bacterial hosts), so that their metabolic activities during ethanol fermentation are benign to the proper performance of ethanol fermenting yeasts.

### General Description of Method(S)

The fundamental innovation outlined in this invention is use of bacteriocin and optionally bacteriocin plus bacteriophage based formulations for the control of unwanted bacteria in the fermentation process, particularly drawn to LAB in the fuel ethanol fermentation.

### Identification of Unwanted Bacteria in a Target Process.

An important step in the carrying out embodiments of the invention is to identify problem (unwanted) bacteria, in order to be able to isolate and propagate effective bacteriocin and/or phages against them.

Unwanted bacteria, or target bacteria, may be identified by sampling the fermentation process feed streams and the fermentation reaction at various times during the process. From samples, unwanted contaminating bacteria can be identified and isolated using classical bacteriological approaches in combination with genetic techniques. For example, numerically dominant isolates of representative morphologies among the contaminating bacterial populations in fermentation samples can be isolated, purified, and their identities determined by sequencing 16 s amplicons. In addition, genetic-based bacterial population diversity analysis on the fermentation samples can be carried out by extracting the total DNA and carrying out 16 s pyrosequencing. Sequences obtained can be compared to a database for target bacterial genera/species identification. Using this approach, we have surveyed multiple commercial ethanol fermentation plants and revealed that the predominant LAB genera (presented in samples at >5% of total bacterial population) identified in nine commercial ethanol fermentation plants include Lactobacillus, Weissella, Streptococcus, Lactococcus, Pediococcus and Enterococcus. Within the predominant LAB genera, more prevalent bacterial species (presented at >=20% of total bacterial populations in any fermentation sample) include L. fermentum, L. musocae, L. lactis, Streptococcus sp., and W. confusa. In these nine ethanol plants, Lactobacillus are the most prevalently present at all fermentation stages accounting for a significant portion (up to 93.3%) of total populations, and there was a general increase in their percentages of total bacterial population from early to late fermentation stage. Similar bacterial diversity survey on commercial ethanol plants will reveal important information on the types of contaminating bacteria, and thus the precise identities of the targets to be controlled in order to develop effective bacteriocin and/or phage product. From these same fermentation samples, virulent bacteriocins and/or bacteriophages may be identified to control target unwanted bacteria.

Lactobacillus species are commonly identified during ethanol fermentation processes. In addition to Lactobacillus species, other target bacteria of interest include, but are not limited to, other lactic acid or acetic acid producing bacteria, such as species in the Pediococcus, Lactococcus, Enterococcus, Weissella, Leuconostoc, Streptococcus, Oenococcus, Acetobactorand Gluconobacter genera. Additional species of unwanted bacteria, including those affecting processes other than yeast-based fuel ethanol fermentation are also target species, as will be evident to those skilled in the art.

Correlations between the general target bacteria identities, different processing stages (such as early, mid, and late fermentations), as well as the undesirable effects cause by target bacteria (symptoms) can be established. Once this background information is available for a given system, diagnosis can be made to some extent and treatment strategies can be determined. For example, high levels of target LAB presented in the early stage of yeast-based corn ethanol fermentation process show more detrimental effects on yeast, compared to contaminations occurred in later stages. It is crucial to apply an effective amount of bacteriocin (with or without virulent phage) to the early-mid fermentation stage biomass in a timely manner to control the target bacteria to a level that is safe for yeast performance.

In many cases multiple bacterial populations work synergistically and sequentially. As such, the target of bacteriocin treatment (and bacteriocin and phage), and therefore, the target unwanted bacteria, can include not just the bacteria competing with and/or inhibiting the system reactive agents, but also any bacteria involved in forming the microenvironment required or contributing to their proliferation.

Bacterial populations responsible for biofilm may result in chronic bacterial contamination in the production process and may also be selected for treatment. All bacteria that are to be targeted for treatment are part of the selected bacterial subpopulation.

### Isolation of Target Strains, Exemplified by LAB in Fuel Ethanol Fermentation Plants

Many LAB bacteriocins (as well as phages) have been identified and isolated, but most are those virulent against dairy associated LAB. While closely related, dairy and fuel ethanol fermentation LAB strains are not identical. Due to the specificity of bacteriocin and phages, it is usually preferable that bacterial strains be used that have been isolated from fuel ethanol fermentation plants, especially those that have been demonstrated to reduce fermentation efficiencies. For example, in ethanol fermentation affected by LAB, Drs. Bischoff, Leathers, and Rich have identified 200 isolates of Lactobacillus species collected from commercial ethanol facilities (Skinner, K. A. and T. D. Leathers (2004). “Bacterial contaminants of fuel ethanol production.” J Ind Microbiol Biotechnol 31(9): 401-8; Bischoff, K. M., K. A. Skinner-Nemec, et al. (2007). “Antimicrobial susceptibility of Lactobacillus species isolated from commercial ethanol plants.” J Ind Microbiol Biotechnol 34(11): 739-44). This collection represents the more common yet genetically distinct Lactobacillus species isolated as contaminants from the fermenters of commercial ethanol facilities experiencing contamination problems. Some Lactobacillus strains were isolated from planktonic cultures (such as L. fermentum 0315-1, L. fermentum 0315-25, and L. brevis 84), while others (such as L. mucosae 0315-2B andL. amylovorus 0315-7B) were associated with biofilm cultures. Many isolated strains were studied for their effects on ethanol fermentation in shake-flask models (Bischoff, Skinner-Nemec et al. 2007).

Isolation and cultivation of target bacteria may be accomplished using traditional bacteriological approaches. For example, Lactobacillus species may be isolated by plating serial dilutions of the fermentation materials onto MRS (Difco Lactobacilli MRS Broth) agar plates supplemented with any chemical capable of specific inhibition of the growth of the fermentative yeast (for example, cyclohexamide may be used for this purpose). Isolates of representative morphologies were isolated, purified, and their identities determined by sequencing 16 s amplicons. Lactobacilli may be grown in simple GasPak jars or in functional hypoxic or anaerobic chambers, which permit easy manipulations and assessment of anaerobic microorganisms.

### Isolation of Bacteriocin

In one permutation of the invention, bacteriocin and/or phage libraries active against the problem causing bacteria are established as a resource to assemble plant-specific bacteriocin and/or phage products. The indigenous contaminating LAB populations in fermentation materials are our control targets since they pose potential risk on yeast fermentation. Since bacteriocins are generally produced by bacterial hosts to kill closely-related strains, bacteriocins produced by the indigenous LAB population in fermentation materials are very likely to act towards different strains of the indigenous LAB population. Fermentation materials, are therefore one of the good sources for LAB bacteriocin isolation. After the indigenous LAB are isolated and purified from the fermentation materials, the capability of the isolated LAB strains to produce antimicrobial compounds is identified using standard microbiological methods. For example, culture supernatants of the strains to be tested are spotted onto individual indicator bacterial culture lawns, which are prepared using a variety of target LAB strains of different genera. After incubation, growth inhibition of the indicator bacteria is seen as a clear zone at and around the spotting position. Any positive activity of bacterial growth inhibition from the tested culture supernatant is confirmed in the same manner, and the inhibitory activity spectrum of the antimicrobial compound is determined. For example, the extracellular antimicrobial compound produced by a Lactobacillus sp. strain, GP15, exhibits broad range killing activity against the vast majority of the LAB isolates in our current strain collection, which include multiple species of Lactobacillus, Laciococcus, Weissella, Leuconostoc, Pediococcus, Enterococcus, Streptococcus, and Staphylococcus. Besides fermentation materials, bacteriocins may also be isolated from other environmental systems where target bacteria exist.

### Isolation of Phage

Bacteriophage virulent for LAB bacteria useful for this invention may be identified, isolated, purified, encapsulated, and commercially produced by means and methods known in the art. See for example U.S. application Ser. No. 13/465,700 filed May 7, 2012, now published application US 2013/0149753; U.S. application Ser. No. 13/466,272 filed May 8, 2012, now published application US 2013/0149759; Published application US 2009/0104157, published Apr. 23, 2009 and WO 2006/050193.

In this invention any of the bacteriophage virulent for LAB found in the fermentation of starches and sugars to ethanol processes may be used as well as bacteria that produce the phages in situ.

### Cocktails and Panels

In most applications of this invention the bacteriocin and phage (and other control components) will be delivered in cocktails, panel or multi-panels in which the desired mix of bacteriocin, phage and other component are preassembled for application to the appropriate point in the process.

### Examples of Bacteriocin Effectiveness

The effect of bacteriocin in controlling contaminating bacteria in corn fermentation mash was tested with results shown in Table 1.

TABLE 1

| | | | # of suseptible | |
|---|---|---|---|---|
| | | | strains to | |
| | | | bacteriocin/# of | |
| | | | total strains | % of |
| | Genus | Species | tested | positive |
| Ethanol | Weissella | Weissella sp. | 2/3 | 97% |
| fermentation | Streptococcus | Streptococcus sp. | 1/3 | 33% |
| plant isolates | | Streptococcus equinus | 2/2 | 100% |
| | Staphylococcus | Staphylococcus sp | 1/1 | 100% |
| | | Staphylococcus [symbol] | 1/1 | 100% |
| | | Staphylococcus [symbol] | 1/1 | 100% |
| | Pedrococcus | Pedrococcus sp. | 2/2 | 100% |
| | | Pedrococcus pentosace [symbol] s | 4/4 | 100% |
| | | Pedrococcus [symbol] | 1/1 | 100% |
| | Leuconostos | Leuconostos sp. | 2/2 | 100% |
| | | Leuconostos mesenteroi [symbol] | 1/1 | 100% |
| | | Leuconostos ge [symbol] deum | 1/1 | 100% |
| | Lactococcus | Lactococcus lactis | 1/3 | 33% |
| | Lactobacillus | Lactobacillus sp | 12/22 | 38% |
| | | Lactobacillus salivenus | 1/1 | 100% |
| | | Lactobacillus [symbol] | 3/3 | 100% |
| | | Lactobacillus plantarum | 3/3 | 100% |
| | | Lactobacillus mucosas | 13/14 | 93% |
| | | Lactobacillus [symbol] | 7/7 | 100% |
| | | Lactobacillus faragnis | 1/1 | 100% |
| | | Lactobacillus diolivorans | 1/1 | 100% |
| | | Lactobacillus deib [symbol] ecks | 5/5 | 100% |
| | | Lactobacillus brevis | 2/2 | 100% |
| | | Lactobacillus amy [symbol] cus | 2/3 | 97% |
| | Enterococcus | Enterococcus sp. | 2/2 | 100% |
| | | Enterococcus [symbol] | 2/2 | 100% |
| | Corynebacterium | Corynebacterium [symbol] | 1/1 | 100% |
| | | Corynebacterium a [symbol] mucosum | 1/1 | 100% |
| | Citrobacter | Citrobacter sp | 1/3 | 30% |
| Other isolates | Desulfotomacufurn | Desulfotomacufurn gutto [symbol] eum | 2/2 | 100% |
| | Desulfotomacufurn | Desulfotomacufurn sp. | 3/3 | 100% |
| | Clostridium | Clostridium saccharofyticum | 3/3 | 100% |
| | Clostridium | Clostridium [symbol] | 1/2 | 50% |
| | Lactococcus | Lactococcus sp. | 5/5 | 100% |
| | Bacilus | Bacilus sp. | 2/2 | 100% |

[symbol]

indicates data missing or illegible when filed

Corn mash was obtained from the fermentor of a commercial ethanol fermentation plant. Crude bacteriocin was added to the mash, and the levels of the contaminating bacteria (CFU/g) were monitored at different time points (immediately upon addition, and 4 hours after addition). Mash without bacteriocin treatment served as the control. The effect of bacteriocin was seen immediately upon its addition (within approximate half an hour, which is the time required to enumerate the bacteria via microbiological plating method). A decrease of approximate 100 fold was observed upon bacteriocin addition, and a decrease of approximate 10,000 fold was observed after four hours. Mash from different commercial plants were tested and in all samples tested, the bacteriocin significantly decreased the contaminating bacteria levels within 4 hours of treatment. The crude bacteriocin used in the efficacy trial was in the form of raw culture supernatant of the producing host. It is reasonable to expect an even more pronounced effect if purified bacteriocin is used at higher doses.

In this specification, the invention has been described with reference to specific embodiments. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. A method of controlling unwanted bacteria in fermentation processes comprising contacting reactants of the process with an effective amount of bacteriocin.

2. The process of claim 1 wherein the process is for production of ethanol from starches or sugars using yeast as the fermentation agent.

3. The process of claim 1 wherein the unwanted bacteria are acid producing bacteria.

4. The process of claim 1 comprising also contacting unwanted bacteria with an effective amount of bacteriophage and/or bacteriophage derived products sufficient to reduce unwanted bacteria.

5. The process of claim 4 comprising bacteriophage virulent for bacteria capable of producing bacteriocin utilized in the process.

6. The process of claim 4 wherein the use of bacteriocin and bacteriophage are sequenced so that bacteriophage producing bacteria, if used in situ, are lysed after effective treatment with bacteriocin.

7. The process of claim 1 wherein the bacteriocin is applied in a cocktail, a panel, a multi-panel or combinations thereof.

8. The process of claim 1 wherein the bacteriocin also comprise Nisin.

9. The process of claim 4 comprising contacting the reactants in the fermentation process with bacteriocin and bacteriophage prior to entering the fermentation stage for sufficient time to reduce unwanted bacteria.

10. The process of claim 4 wherein feed reactant to a fermentation step of the fermentation process and the yeast entering the fermentation step are contacted with bacteriocin effective to reduce unwanted bacteria.

11. The process of claim 10 also comprising contact with bacteriophage virulent for bacteria capable of producing bacteriocin utilized in the process.

12. The process of claim 1 comprising contacting the unwanted bacteria with bacteria capable of producing bacteriocin virulent for the unwanted bacteria in a sufficient amount and for sufficient time for the bacteriocin bacteria to produce an effective amount of bacteriocin virulent for unwanted bacteria.

13. The process of claim 12 comprising also contacting unwanted bacteria with an effective amount of bacteriophage sufficient to reduce unwanted bacteria.

14. The process of claim 1 wherein the fermentation process is a fermentation process for conversion of sugars from a solution of sugars to ethanol comprising fermentation feed preparation steps, fermentation steps and yeast propagation steps and wherein unwanted bacteria in the sugar solution are contacted with bacteriocin and products of the yeast processing step is contacted with bacteriocin, the bacteriocin in each case being tailored to the unwanted bacteria of the solution or product.

15. A process for control of unwanted bacteria in fermentation product process comprising;
identifying unwanted bacteria;
locating and isolating bacteriocin virulent for some or all of the identified unwanted bacteria;
contacting the unwanted bacteria with an effective amount and for an effective time to destroy an identifiable amount of some or all of the unwanted bacteria.

16. The method of claim 15 wherein the process is fermentation of sugars to ethanol.

17. The method of claim 15 wherein the unwanted bacteria are acid producing bacteria.

18. The method of claim 15 comprising also contacting reactants in the process with bacteriocin and an effective amount of bacteriophage sufficient to reduce unwanted bacteria.

19. A method of producing bacteriocin for use in reducing unwanted bacteria in fermentation processes comprising producing bacteriocin with native expression systems in native bacterial host strains, including bacteriocin-producing LAB strains.

20. A method of producing bacteriocin for use in reducing unwanted bacteria in fermentation processes comprising producing bacteriocin with heterologous expression systems utilizing bacteria hosts selected from the group consisting of, but not limit to, Escherichia coli, species of Lactococcus, Enterococcus, Lactobacillus and Pediococcus.

21. A method of producing bacteriocin for use in reducing unwanted bacteria in fermentation processes comprising utilizing bacteriocin-producing bacteriophage including bacteriophage into which generic bacteriocin determinants have been engineered.

22. The method of claim 20 wherein the phage of are of high burst size.

23. The method of claim 20 wherein the bacteriocin-producing phage are incorporated into the fermentation process step to produce the desired bacteriocin in situ.

24. A method of producing bacteriocin for use in reducing unwanted bacteria in fermentation processes comprising utilizing bacteriocin-producing eukaryotic cells including yeast cells.
